(19) United States
(12) Patent Application Publication
(10) Pub. No.: US 2005/0229489 A1
(43) Pub. Date: Oct. 20, 2005

(54) Apparatus and method for hydrogen generation

(75) Inventors: Farshad A. Bavarian, Houston, TX (US); James F. Stevens, Katy, TX (US)

Correspondence Address: FRANK C. TURNER;CHEVRON SERVICES COMPANY, LAW DEPARTMENT, P.O. BOX 3725, HOUSTON, TX, 77253-3725, US

(73) Assignees: Texaco Inc., San Ramon, CA (US); TEXACO DEVELOPMENT CORPORATION, San Ramon, CA (US)

(21) Appl. No.: 10/827,187

(22) Filed: Apr. 19, 2004

(51) Int. Cl. C01B 3/24

(52) U.S. Cl. 48/198.7; 48/127.9; 48/128; 48/198.3

(57) ABSTRACT

Apparatus and method for converting hydrocarbon fuels to hydrogen-rich reformate that incorporate a carbon dioxide fixing mechanism into the initial hydrocarbon conversion process. The mechanism utilizes a carbon dioxide fixing material within the reforming catalyst bed to remove carbon dioxide from the reformate product. The bed optionally contains a water gas shift catalyst. The removal of carbon dioxide from the product stream shifts the reforming reaction and shift reaction equilibria toward production of higher concentrations of hydrogen with only small amounts of carbon oxides produced. The carbon oxide-depleted reformate is directed to a purification bed comprising a hydrogen fixing material that removes hydrogen from the reformate stream to provide fixed hydrogen and a hydrogen-depleted reformate that flows out of the purification bed. The purification bed is heated to release fixed hydrogen from the hydrogen fixing material to provide a highly pure hydrogen gas.

### FIELD OF THE INVENTION

The present invention relates to the field of fuel processing wherein hydrocarbon-based fuels are converted to a hydrogen-enriched reformate for ultimate use in hydrogen-consuming devices and processes. The fuel processing methods of the present invention provide a hydrogen-rich reformate of high purity by utilizing absorption enhanced reforming wherein a by-product, such as carbon dioxide, is absorbed or removed from the product stream to shift the conversion reaction equilibrium toward higher hydrocarbon conversion rates with smaller amounts of by-products produced.

### BACKGROUND OF THE INVENTION

Hydrogen is utilized in a wide variety of industries ranging from aerospace to food production to oil and gas production and refining. Hydrogen is used in these industries as a propellant, an atmosphere, a carrier gas, a diluent gas, a fuel component for combustion reactions, a fuel for fuel cells, as well as a reducing agent in numerous chemical reactions and processes. In addition, hydrogen is being considered as an alternative fuel for power generation because it is renewable, abundant, efficient, and unlike other alternatives, produces zero emissions. While there is wide-spread consumption of hydrogen and great potential for even more, a disadvantage which inhibits further increases in hydrogen consumption is the absence of a hydrogen infrastructure to provide widespread generation, storage and distribution. One way to overcome this difficulty is through distributed generation of hydrogen, such as through the use of fuel reformers to convert a hydrocarbon-based fuel to a hydrogen-rich reformate.

Fuel reforming processes, such as steam reforming, partial oxidation, and autothermal reforming, can be used to convert hydrocarbon fuels such as natural gas, LPG, gasoline, and diesel, into hydrogen-rich reformate at the site where the hydrogen is needed. However, in addition to the desired hydrogen product, fuel reformers typically produce undesirable impurities that reduce the value of the reformate product. For instance, in a conventional steam reforming process, a hydrocarbon feed, such as methane, natural gas, propane, gasoline, naphtha, or diesel, is vaporized, mixed with steam, and passed over a steam reforming catalyst. The majority of the hydrocarbon feed is converted to a mixture of hydrogen and impurities such as carbon monoxide and carbon dioxide. The reformed product gas is typically fed to at least one water-gas shift bed in which the carbon monoxide is reacted with steam to form carbon dioxide and hydrogen. After the shift reaction(s), additional purification steps are required to bring the reformate purity to acceptable levels. These steps can include, but are not limited to, methanation, selective oxidation reactions, passing the product stream through membrane separators, as well as pressure swing and temperature swing absorption processes. While such purification technologies may be known, the added cost and complexity of integrating them with a fuel reformer to produce sufficiently pure hydrogen reformate can render their construction and operation impractical.

In terms of power generation, fuel cells typically employ hydrogen as fuel in catalytic oxidation-reduction reactions to produce electricity. As with most industrial applications utilizing hydrogen, the purity of the hydrogen used in fuel cell systems is critical. Specifically, because power generation in fuel cells is proportional to the consumption rate of the reactants, the efficiencies and costs of fuel cells can be improved through the use of a highly pure hydrogen reformate. Moreover, the catalysts employed in many types of fuel cells can be deactivated or permanently impaired by exposure to certain impurities that are commonly found in conventionally reformed fuels. As a result, an improved yet simplified reforming apparatus and process capable of providing a high purity hydrogen reformate that is low in carbon oxides is greatly desired.

The disclosure of U.S. Pat. No. 6,682,838, issued to Stevens, Jan. 27, 2004, is incorporated herein by reference.

### SUMMARY OF THE INVENTION

In one aspect of the instant invention, an apparatus for generating a hydrogen-rich reformate is provided. The apparatus includes a reactor comprising a catalyst bed that includes a reforming catalyst suitable for converting a hydrocarbon fuel to a reformate comprising hydrogen and carbon dioxide, a carbon dioxide fixing material suitable for fixing at least a portion of the carbon dioxide in the reformate within the catalyst bed to produce an intermediate reformate rich in hydrogen, and optionally, a water gas shift catalyst. In some embodiments, the reforming catalyst and carbon dioxide fixing material have a non-uniform distribution within the catalyst bed. The reactor can also optionally include heat exchanging means for delivering heat to and/or removing heat from the carbon dioxide fixing material.

The apparatus also includes a first purification bed in fluid communication with the reactor for receiving the intermediate reformate from the reactor. The first purification bed includes a hydrogen fixing material suitable for fixing at least a portion of the hydrogen in the intermediate reformate to provide a hydrogen-depleted gas and fixed hydrogen. The hydrogen fixing material can include a metal hydride forming material. Inert material with a high heat capacity can also be dispersed with the hydrogen fixing material within the first purification bed. In some embodiments, the first purification bed can include a vessel having an inlet, an outlet and a gas passage extending from the inlet to the outlet with the hydrogen fixing material disposed within the gas passage. Optionally, the first purification bed can include heat exchanging means for delivering heat to and/or removing heat from the hydrogen fixing material.

The apparatus can optionally include a desulfurization unit disposed upstream of the reactor for removing sulfur-containing compounds from the hydrocarbon fuel, a polishing unit disposed upstream from the first purification bed for removing one or more impurities from the intermediate reformate. Preferably, the polishing unit comprises a drying unit for removing water from the reformate, and/or a methanation unit disposed upstream from the first purification bed for removing carbon oxides from the intermediate reformate. In some embodiments, the apparatus can further include a hydrogen storage device disposed downstream in fluid communication with the first purification bed. In other embodiments, the apparatus can include a controller for controlling the operation of the reactor(s) and/or the purification bed(s).

In still other embodiments, the apparatus can further include a second purification bed and a manifold disposed downstream of the reactor for diverting reformate between the first purification bed and the second purification bed. In such embodiments, a first heat exchanging means disposed within the first purification bed and a second heat exchanging means disposed within the second purification are operably connected so as to provide for heat transfer between the first and second purification beds.

In a process aspect of the instant invention, a method for generating hydrogen is provided. The method includes the step of reacting a hydrocarbon fuel in a catalyst bed that comprises a reforming catalyst, carbon dioxide fixing material, and optionally, a water gas shift catalyst, to produce a reformate comprising hydrogen and carbon dioxide. The carbon dioxide fixing material fixes at least a portion of the carbon dioxide in the reformate to produce an intermediate reformate. Preferably, the intermediate reformate has a carbon monoxide concentration of less than about 5 ppm.

Hydrogen is removed from the intermediate reformate by flowing the intermediate reformate through a first purification bed comprising a hydrogen fixing material to produce a hydrogen-depleted gas and fixed hydrogen. The hydrogen fixing material can include a metal hydride-forming material, and optionally, an inert material having a high heat capacity. Heat can optionally be removed from the purification bed to promote the hydrogen fixing reaction. Optionally, water can be removed from the intermediate reformate and/or the intermediate reformate can be methanated prior to flowing the intermediate reformate through the first purification bed. The method can include monitoring the composition of the hydrogen-depleted gas, interrupting the flow of intermediate reformate through the first purification bed, and/or purging the first purification bed to remove residual hydrogen-depleted gas prior to releasing fixed hydrogen.

The method includes the step of releasing fixed hydrogen from the first purification bed to produce a hydrogen-rich gas. Fixed hydrogen can be released from the first purification bed by imposing a change in temperature, pressure or a combination of changes in temperature and pressure on the hydrogen fixing material.

The method can also include diverting the intermediate reformate from the first purification bed and flowing the intermediate reformate through a second purification bed comprising a hydrogen fixing material to produce a hydrogen-depleted gas and fixed hydrogen. Fixed hydrogen can be released from the first purification bed while the intermediate reformate is flowing through the second purification bed. In some embodiments, fixed hydrogen is released from the first purification bed by heating the hydrogen fixing material in the first purification bed with heat derived from the second purification bed. Fixed hydrogen can be released from the second purification bed by imposing a change in temperature, pressure or a combination of changes in temperature and pressure on the hydrogen fixing material.

### BRIEF DESCRIPTION OF THE DRAWINGS

The invention may be understood by reference to the following description taken in conjunction with the accompanying drawings.

FIG. 1 is a schematic view of an apparatus of the instant invention.

FIG. 2 is a schematic view of an apparatus of the instant invention.

FIG. 3 is a schematic view of an apparatus of the instant invention.

FIG. 4A is a graphical illustration of a hydrogen-depleted gas composition exiting a purification bed of the instant invention during hydrogen absorption.

FIG. 4B is a graphical illustration of a hydrogen-rich gas composition exiting a purification bed of the instant invention during hydrogen desorption.

FIG. 5A is a graphical illustration of a hydrogen-depleted gas composition exiting a purification bed of the instant invention during hydrogen absorption.

FIG. 5B is a graphical illustration of the hydrogen concentration of a hydrogen-rich gas exiting a purification bed of the instant invention during hydrogen desorption.

FIG. 5C is a graphical illustration of the methane concentration of a hydrogen-rich gas exiting a purification bed of the instant invention during hydrogen desorption.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE PREFERRED EMBODIMENTS

Illustrative embodiments of the invention are described below. In the interest of clarity, not all features of an actual embodiment are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover it will be appreciated that such a development effort might be complex and time-consuming, but would nevertheless be a routine undertaking for those of ordinary skill in the art having the benefit of this disclosure.

Apparatus for Generating Hydrogen

An apparatus of the instant invention comprises a reforming reactor comprising a catalyst bed that comprises a reforming catalyst suitable for converting a hydrocarbon fuel to a reformate comprising hydrogen and carbon dioxide, a carbon dioxide fixing material suitable for fixing within the catalyst bed at least a portion of the carbon dioxide in the reformate to provide an intermediate reformate rich in hydrogen, and optionally, a water gas shift catalyst. The apparatus further comprises a first purification bed comprising a hydrogen fixing material suitable for fixing at least a portion of the hydrogen in the intermediate reformate.

The instant invention is generally directed to apparatus and methods for converting a hydrocarbon-based fuel to a hydrogen-rich gas. The invention simplifies the production of a highly pure hydrogen-rich gas by incorporating a carbon dioxide fixing mechanism into the initial hydrocarbon conversion process. This mechanism utilizes a carbon dioxide fixing material within the reforming catalyst bed that will react with and/or retain carbon dioxide under reaction conditions that are typical for conversion reactions of hydrocarbon to hydrogen and carbon oxides. Hydrocarbon to hydrogen conversion reactions that utilize such carbon dioxide fixing materials are generally referred to herein as “absorption enhanced reforming” as the absorption or removal of carbon dioxide from the reformed product shifts the reforming reaction equilibrium toward the production of higher levels of hydrogen and lower levels of carbon oxides.

Absorption enhanced reforming generates a hydrogen-rich reformate by conducting multiple reactions within a common reactor catalyst bed. Typical reactions that may be performed within the catalyst bed include fuel reforming reactions such as steam and/or autothermal reforming reactions that generate a reformate containing hydrogen, carbon oxides and potentially other impurities, water gas shift reactions wherein water and carbon monoxide are converted to hydrogen and carbon dioxide, and carbonation reactions wherein carbon dioxide is physically absorbed or chemically converted to preferably a non-gaseous species. Chemical equations for such a combination of reactions using methane as the hydrocarbon fuel and calcium oxide as the carbon dioxide fixing material are as follows:

| | | |
|---|---|---|
| CH₄ + H₂O → 3H₂ + CO | (Steam Reforming) | (I) |
| H₂O + CO → H₂ + CO₂ | (Water Gas Shift) | (II) |
| CO₂ + CaO → CaCO₃ | (Carbonation) | (III) |
| CH₄ + 2H₂O + CaO → 4H₂ + CaCO₃ | (Combined) | (IV) |

While these equations exemplify the conversion of methane to a hydrogen-rich reformate, the scope of the invention should not be construed as being so limited.

Suitable reactors for use in the apparatus and methods of the instant invention comprise a reactor vessel having an inlet for receiving a hydrocarbon fuel and an outlet for delivering an intermediate reformate. The inlet of the reactor vessel is preferably connected to sources of hydrocarbon fuel and steam. Optionally, where a hydrocarbon fuel to be utilized in the reactor vessel comprises sulfur-containing compounds, a desulfurization unit can be connected to the vessel to reduce the sulfur content of the fuel. A source of air, oxygen, or oxygen-enriched air can also be connected to the reactor vessel, such as where the intended reforming reaction is an autothermal reforming reaction. Separate inlets for hydrocarbon fuel(s), steam, and/or air may be utilized, or in an alternative, two or more of such materials may be combined and mixed outside the reactor vessel and introduced as a mixture through a common inlet. Heated mixtures of hydrocarbon fuel and oxidants should be avoided so as to prevent the undesired oxidation of materials.

The reactor vessel includes a catalyst bed disposed within the vessel that comprises a reforming catalyst, preferably a steam reforming catalyst, optionally a water gas shift catalyst, and a carbon dioxide fixing material.

The reforming catalyst(s) may be in any form including pellets, spheres, extrudates, monoliths, as well as common particulates and agglomerates. Conventional steam reforming catalysts are well known in the art and can include nickel with amounts of cobalt or a noble metal such as platinum, palladium, rhodium, ruthenium, and/or iridium. The catalyst can be supported, for example, on magnesia, alumina, silica, zirconia, or magnesium aluminate, singly or in combination. Alternatively, the steam reforming catalyst can include nickel, preferably supported on magnesia, alumina, silica, zirconia, or magnesium aluminate, singly or in combination, promoted by an alkali metal such as potassium. Where the reforming reaction is preferably a steam reforming reaction, the reforming catalyst preferably comprises rhodium on an alumina support. Suitable reforming catalysts are commercially available from companies such as Cabot Superior Micropowders LLC (Albuquerque, N. Mex.) and Engelhard Corporation (Iselin, N.J.).

Reaction temperatures of an autothermal reforming reaction can range from about 550° C. to about 900° C. depending on the feed conditions and the catalyst. In a preferred embodiment, the reforming reaction is a steam reforming reaction with a reforming temperature in the range from about 400° C. to about 800° C., preferably in the range from about 450° C. to about 700° C., and more preferably in the range from about 500° C. to about 650° C.

Certain catalysts have been found to exhibit activity for both a reforming and water gas shift reaction. In particular, it has been found that a rhodium catalyst on alumina support will catalyze both a steam methane reforming reaction and a water gas shift reaction under the conditions present in the catalyst bed. In such circumstances, the use of a separate water gas shift catalyst is not required. Where the selected reforming catalyst does not catalyze the shift reaction, a separate water gas shift catalyst is a highly preferred component of the catalyst bed.

A water gas shift catalyst can be used within the catalyst bed to promote the conversion of steam and carbon monoxide to hydrogen and carbon dioxide. The consumption of carbon monoxide by a shift reaction upgrades the value of the hydrogen-rich reformate gas as carbon monoxide is a well known poison to many catalyst systems including those used in fuel cells and petrochemical refining. The maximum level of carbon monoxide in the hydrogen-rich reformate should be a level that can be tolerated by fuel cells, a level that is typically below about 50 ppm. In addition, there is growing demand for even higher purity hydrogen reformate streams that have carbon monoxide concentrations below about 25 ppm, preferably below about 15 ppm, more preferably below 10 ppm, and still more preferably below about 5 ppm.

In terms of reaction temperatures, water gas shift reactions generally occur at temperatures of from about 150° C. to about 600° C. depending on the catalyst used. Low temperature shift catalysts operate at a range of from about 150° C. to about 300° C. and include for example, copper oxide, or copper supported on other transition metal oxides such as zirconia, zinc supported on transition metal oxides or refractory supports such as silica, alumina, zirconia, etc., or a noble metal such as platinum, rhenium, palladium, rhodium or gold on a suitable support such as silica, alumina, zirconia, and the like. High temperature shift catalysts are preferably operated at temperatures ranging from about 300° C. to about 600° C. and can include transition metal oxides such as ferric oxide or chromic oxide, and optionally include a promoter such as copper or iron silicide. Suitable high temperature shift catalysts also include supported noble metals such as supported platinum, palladium and/or other platinum group members. Suitable water gas shift catalysts are commercially available from companies such as Cabot Superior Micropowders LLC (Albuquerque, N. Mex.) and Engelhard Corporation (Iselin, N.J.).

The catalyst bed will also include a carbon dioxide fixing material. As used in this disclosure, “carbon dioxide fixing material” is intended to refer to materials and substances that react or bind with carbon dioxide at a temperature within the range of temperatures that is typical of hydrocarbon conversion to hydrogen and carbon oxides. Such carbon dioxide fixing materials include, but are not limited to, those materials that will adsorb or absorb carbon dioxide as well as materials that will convert carbon dioxide to a chemical species that is more easily removed from the reformate gas stream. In addition, suitable fixing materials must be stable in the presence of steam at reforming temperatures, should maintain a high carbon dioxide fixing capacity over multiple reforming/calcination cycles, should be low in toxicity and pyrophoricity, and preferably low in cost.

Suitable carbon dioxide fixing materials can comprise an alkaline earth oxide(s), a doped alkaline earth oxide(s) or mixtures thereof. Preferably, the carbon dioxide fixing material will comprise calcium, strontium, or magnesium salts combined with binding materials such as silicates or clays that prevent the carbon dioxide fixing material from becoming entrained in the gas stream and reduce crystallization that decreases surface area and carbon dioxide absorption. Salts used to make the initial bed can be any salt, such as an oxide and/or hydroxide that will convert to the carbonate under process conditions. Specific substances that are capable of fixing carbon dioxide in suitable temperature ranges include, but are not limited to, calcium oxide (CaO), calcium hydroxide (Ca(OH)₂), strontium oxide (SrO), strontium hydroxide (Sr(OH)₂) and mixtures thereof.

Other suitable carbon dioxide fixing materials can include those materials described in U.S. Pat. No. 3,627,478 issued Dec. 14, 1971 to Tepper, (describing the use of weak base ion exchange resins at high pressure to absorb CO₂); U.S. Pat. No. 6,103,143 issued Aug. 15, 2000 to Sircar et al., (describing a preference for the use of modified double layered hydroxides represented by the formula [Mg₍₁₋ₓ₎Alₓ(OH)₂][CO₃]_{x/2yH2}O.zM′₂CO₃ where 0.09≦x≦0.40, 0≦y≦3.5, 0≦z≦3.5 and M′=Na or K, and spinels and modified spinels represented by the formula Mg[Al₂]O₄.yK₂CO₃ where 0≦y≦3.5); U.S. Patent Application Publication No. 2002/0110503 A1 published Aug. 15, 2002 by Gittleman et al., (describing the use of metal and mixed metal oxides of magnesium, calcium, manganese, and lanthanum and the clay minerals such as dolomite and sepiolite); and U.S. Patent Application Publication No. 2003/0150163 A1 published Aug. 14, 2003 by Murata et al., (describing the use of lithium-based compounds such as lithium zirconate, lithium ferrite, lithium silicate, and composites of such lithium compounds with alkaline metal carbonates and/or alkaline earth metal carbonates); the disclosures of each of which are incorporated herein by reference. In addition, suitable mineral compounds such as allanite, andralite, ankerite, anorthite, aragoniter, calcite, dolomite, clinozoisite, huntite, hydrotalcite, lawsonite, meionite, strontianite, vaterite, jutnohorite, minrecordite, benstonite, olekminskite, nyerereite, natrofairchildite, farichildite, zemkorite, butschlite, shrtite, remondite, petersenite, calcioburbankite, burbankite, khanneshite, carboncemaite, brinkite, pryrauite, strontio dressenite, and similar such compounds and mixtures thereof, can be suitable materials for fixing carbon dioxide.

One or more of the described carbon dioxide fixing materials may be preferred depending on such variables as the hydrocarbon fuel to be reformed, the selected reforming reaction conditions and the specification of the hydrogen-rich gas to be produced. In addition, the fixing material selected should exhibit low equilibrium partial pressure of carbon dioxide in the temperature range of about 400° C. to about 650° C. and high equilibrium partial pressure of carbon dioxide at temperatures from about 150° C. to about 400° C. above the selected reforming reaction temperature.

The carbon dioxide fixing material may take any of the forms suggested above for catalysts, including pellets, spheres, extrudates, monoliths, as well as common particulates and agglomerates. In addition, the catalyst(s) and carbon dioxide fixing material may be combined into a mixture in one or more of the forms suggested above. In some embodiments, the carbon dioxide fixing material will be combined with catalyst(s) to form a mixture that is processed into a particulate composite using an aerosol method such as that disclosed in U.S. Pat. No. 6,685,762 issued Feb. 3, 2004, to Brewster, et al., the contents of which are incorporated herein by reference.

Although conventional catalyst beds having multiple components tend to have a uniform distribution of components through the bed, it has been found that superior conversion rates can be achieved with absorption enhanced reforming when the catalyst(s) and carbon dioxide fixing materials have a non-uniform distribution within the bed. Specifically, the catalyst composition nearest the bed inlet should contain an amount of reforming catalyst that is greater than the average level of reforming catalyst across the bed. Similarly, the composition nearest the bed outlet should contain an amount of reforming catalyst that is less than the average level of reforming catalyst across the bed. This non-uniform distribution of reforming catalyst can be achieved by providing a generally smooth distribution of reforming catalyst that decreases across the bed from the inlet to the outlet or by providing a plurality of reaction zones that have generally decreasing concentrations of reforming catalyst ranging from the inlet to the outlet. It should be noted that neither of such distributions should be interpreted as excluding the possibility that a downstream region or reaction zone within the catalyst bed can have a higher concentration of reforming catalyst than an upstream region reaction zone.

A more specific example of a zoned approach is to provide a catalyst bed with a plurality of reaction zones that include an inlet zone near the bed inlet, an outlet zone near the bed outlet, and one or more optional intermediate zones disposed therebetween. Such a plurality of reactions zones within the catalyst bed can have the same or similar dimensions, and thus, account for relatively equal volumes of the bed, or alternatively, their dimensions and relative volumes can differ significantly. In such an embodiment, the inlet zone can comprise a first catalyst composition that includes a reforming catalyst, and an optional water gas shift catalyst. Preferably, carbon dioxide fixing material is absent or in relatively low concentrations in such a first catalyst composition. An intermediate zone can comprise a second catalyst composition comprising two or more of a reforming catalyst, a carbon dioxide fixing material, and a water gas shift catalyst. The outlet zone preferably comprises a mixture of a carbon dioxide fixing material, and optionally, a water gas shift catalyst. Carbon dioxide that is produced as a result of the reforming and shift reactions in the inlet and intermediate zones is fixed in the intermediate and outlet zones. Although reforming catalyst can be present in the outlet zone, it is preferred that the outlet zone comprise less than 50% by volume of a reforming catalyst. In some embodiments, the outlet zone will comprise less than about 40%, preferably less than about 30%, more preferably less than about 20%, and still more preferably less than about 10% by volume of a reforming catalyst. In a preferred embodiment, reforming catalyst will be absent from an outlet zone so that carbon dioxide is not produced by a reforming reaction occurring near the catalyst bed outlet. A more detailed description of a catalyst bed having a non-uniform distribution of catalyst(s) and carbon dioxide fixing material may be found in U.S. patent application entitled “Reactor with Carbon Dioxide Fixing Material”, by Stevens, et al., filed Apr. 19, 2004 (Attorney Docket No. X-0148), the contents of which are incorporated herein by reference.

Preferably, the catalyst bed is a fixed bed such that the carbon dioxide fixing material is not withdrawn for the purpose of releasing fixed carbon dioxide but is calcinated in place within the reforming catalyst bed.

Catalyst bed support means for supporting the catalyst bed within the reactor vessel can also be utilized. Catalyst bed support means will include inert support materials such as various ceramic materials that may be loaded into the reactor vessel below the catalyst bed. In addition, catalyst bed support means can also include refractory bricks or perforated or slotted support members that span the reactor and provide support for support materials and the catalyst bed. The selection and installation of catalyst bed support means within the lower portion of the reactor vessel should take into consideration the pressure drop that may be imposed by such elements so that the pressure requirements of the hydrogen produced are satisfied.

In another embodiment, heat exchanging means for removing heat from and/or delivering heat to the catalyst bed and the carbon dioxide fixing material therein can optionally be incorporated into the design of the catalyst bed, the catalyst bed support means or simply imbedded amongst the catalyst bed components. The heat exchanging means can be capable of generating heat such as electrically resistant heating coils that are embedded within the catalyst bed. Alternatively, the heat exchanging means may comprise heat exchanging surfaces within the catalyst bed that are operably coupled with separate heat generating means. Suitable heat generating means can be any conventional heating units such as resistant heating coils, burners or combustors, but may also be fuel cell and/or hydrogen storage system that generate heated exhaust gases. Further, heat from the heat exchanging means can be provided directly to the catalyst bed and/or used to pre-heat feeds to the bed.

The heat exchanging means should be capable of raising the bed temperature to a reforming temperature and/or to a calcination temperature depending on the operational mode of the reactor. When used, heat exchanging means is preferably a heat exchanger, heat pipe or other heat transfer device having sufficient heat transfer capability to raise the bed temperature to the desired operational temperature. In a preferred embodiment, the heat exchanging means will comprise a heat exchanger coil or heat pipe operably coupled to heat generating means capable of providing variable heat so that the amount of heat delivered to the catalyst bed can be adjusted to achieve the appropriate reforming and calcination temperatures.

In some embodiments, two or more heat generating means can be used to provide heat to the catalyst bed within different temperature ranges. More specifically, one heat generating means generates heat for heating the catalyst bed to a reforming reaction temperature and a second heat generating means generates heat for heating a catalyst bed to a calcinating temperature. Where two or more reforming catalyst beds are utilized such that one bed is in reforming mode while simultaneously a second bed is heated to a calcination temperature, it is preferred that the two heat generating means be thermally integrated so as to improve the thermal efficiency of the apparatus. Thermal integration can be achieved by pre-heating reforming reactant feeds such as hydrocarbon fuel and steam with the excess heat that is generated for heating the second catalyst bed to a calcination temperature. Where the heat generating means comprise a burner or combustor, oxidant(s) to be reacted can likewise be pre-heated to improve the thermal integration and efficiency of the apparatus.

In some embodiments, the carbon dioxide fixing material can be heated to a calcination temperature by heated oxidation products produced by an oxidation reaction within the reaction vessel itself. In such an embodiment, the oxidation reaction can occur either within or external to the catalyst bed. In a preferred embodiment, an oxidation zone is disposed within the reactor vessel outside of the catalyst bed so that carbon or other oxidation by-products are not deposited within the catalyst bed. When the oxidation zone is disposed upstream of the catalyst bed such that the heated oxidation products flow through the catalyst bed, the reactor can optionally include a moderator inlet for introducing a temperature moderator into the oxidation zone for controlling the temperature of the heated oxidation products. In addition, the reactor vessel can comprise an oxidant inlet for directing oxidant into the oxidation zone. In other embodiments, an ignition source such as a spark plug or the like can optionally be disposed within the oxidation zone for initiating the oxidation reaction. Further, a heat transfer device can be used to facilitate the transfer of heat between the catalyst bed and the oxidation zone, particularly when the oxidation zone is disposed downstream of the catalyst bed or external to the reactor vessel. In addition, the reactor vessel can optionally comprise thermocouples or other temperature sensing means for monitoring temperatures at various locations within the reactor vessel. Reactors that utilize heated oxidation products to calcinate a carbon dioxide fixing material are described in greater detail in U.S. Patent Application Publication No. 2002/0085967 A1, published Jul. 4, 2002 by Yokata; U.S. Patent Application Publication No. 2003/0150163 A1, published Aug. 14, 2003 by Murata, et al.; and U.S. patent application “Reactor and Apparatus for Hydrogen Generation”, by Stevens, et al., Attorney Docket No. X-0186, filed Apr. 19, 2004, the disclosures of each of which is incorporated herein by reference.

Reactor vessels, purification beds, and other process equipment described herein may be fabricated from any material capable of withstanding the operating conditions and chemical environment of the reactions described, and can include, for example, carbon steel, stainless steel, Inconel, Incoloy, Hastelloy, and the like.

Preferably, the reactor vessel will have a side wall that comprises a refractory material such as a ceramic type refractory material, including but not limited, to silicon carbide, silicon nitride or any other suitable known advanced ceramic composite. The operating pressure for the reactor vessel and other process units are preferably from about 0 to about 100 psig, although higher pressures may be employed. Ultimately, the operating pressure will depend upon the delivery pressure required of the hydrogen produced. Where the hydrogen is to be delivered to a fuel cell operating in the 1 to 20 kW range, an operating pressure of 0 to about 100 psig is generally sufficient. Higher pressure conditions may be required depending on the hydrogen requirements of the end user. As described herein, the operating temperatures within the reactor vessel will vary depending on the type reforming reaction, the type of reforming catalyst, the carbon dioxide fixing material, the water gas shift catalyst, and selected pressure conditions amongst other variables.

The apparatus can further comprise a desulfurization unit for removing sulfur-containing compounds from the hydrocarbon fuel prior to use of the fuel within the reactor. Devices and systems for removing sulfur-containing compounds from hydrocarbon fuels are well known in the petrochemical arts. It is preferred that the desulfurization unit comprise an absorbent and/or catalyst bed for removing sulfur from a hydrocarbon fuel flowing through the bed. Suitable desulfurization sorbents and catalysts can comprise alkali salts such as alkali metal compounds including metal oxides, silica based compounds including zeolites, activated alumina, activated carbon, compounds and composites of metals such as nickel, cobalt, iron, manganese, tungsten, silver, gold, copper, platinum, zinc, tin, ruthenium, molybdenum, antimony, vanadium iridium, platinum, chromium and palladium, and various inerts and support materials. Additional detail concerning suitable desulfurization units and devices may be found in U.S. Pat. No. 5,059,406 issued Oct. 22, 1991 to Sheth, et al.; U.S. Pat. No. 6,454,935 B1 issued Sep. 24, 2002 to Lesieur, et al.; U.S. Patent Application Publication No. 2003/0113598 A1, published Jun. 19, 2003 by Chow, et al.; U.S. Patent Application Publication No. 2003/0188993 A1, published Oct. 9, 2003 by Khare, et al.; and U.S. Patent Application Publication No. 2004/0063576 A1, published Apr. 1, 2004 by Chow, et al., the descriptions of each of which is incorporated herein by reference. The apparatus of the instant invention preferably includes a desulfurization unit comprising a bed containing a portion of zinc oxide.

The apparatus can further include a polishing unit that is in fluid communication with the reactor intermediate the reactor and the purification bed. The polishing unit is disposed upstream from the purification bed for removing one or more impurities from the intermediate reformate that might harm the hydrogen fixing material or otherwise interfere with the hydrogen fixing mechanism. The polishing unit can be a drying unit, a methanation reactor, selective oxidation reactor, pressure swing absorption unit, temperature swing absorption unit and/or a membrane separator. Two or more polishing units may be employed to remove reformate impurities. In some embodiments, the polishing unit is a drying unit for removing water from the intermediate reformate before the reformate is flowed through the purification bed. In other embodiments, the polishing unit is a methanation reactor for converting carbon oxides and hydrogen to methane. Because the level of carbon oxides in the reformate is particularly low, the amount of hydrogen that is required to convert the carbon oxides to methane is not considered to be significant. Further, the methane can remain in the hydrogen-rich reformate and pass through the purification bed without harming the hydrogen fixing material. In a preferred embodiment, the polishing unit will comprise a methanator for removing residual carbon monoxide, and disposed downstream of the methanator, a drying unit to remove water form the intermediate reformate.

An apparatus of the instant invention further includes a purification bed disposed downstream of the reactor for receiving an intermediate reformate that is low in carbon oxides and rich in hydrogen. The purification bed comprises a hydrogen fixing material, and optionally, an inert material having a high heat capacity.

As used in this disclosure, “hydrogen fixing material” is intended to refer to materials and substances that reversibly adsorb or absorb hydrogen as well as those materials that can reversibly react with hydrogen to remove it from the intermediate reformate. Suitable hydrogen fixing materials can include activated carbon, carbon composites, fullerene based materials, metal hydride-forming materials, alloys comprising a mixture of titanium, vanadium, chromium and manganese, and nanostructures formed from elements of the second and/or third rows of the periodic table. In a preferred embodiment, the hydrogen fixing material comprises a metal hydride-forming material. Metal hydride-forming materials are commercially available and well known in the hydrogen storage arts. Detailed descriptions of suitable metal hydride-forming materials may be had by reference to U.S. Pat. No. 4,108,605, issued Aug. 22, 1978 to Billings; U.S. Pat. No. 4,360,505 issued Nov. 23, 1982 to Sheridan III, et al.; U.S. Pat. No. 4,566,281 issued Jan. 28, 1986 to Sandrock, et al.; U.S. Pat. No. 4,687,650 issued Aug. 18, 1987 to Goodell, et al.; U.S. Pat. No. 4,696,806 issued Sep. 29, 1987 to Peterson, et al.; U.S. Pat. No. 4,749,558 issued Jun. 7, 1988 to Bogdanovic; U.S. Pat. No. 5,080,875 issued Jan. 14, 1992; “Hydrogen purification using fluorinated LaNi_{4.7}Al_{0.3} Alloy,” Wang, et al., Journal of Alloys and Compounds, Vol. 231 (1995), pp. 860-864; “Hydrogen purification with metal hydride sintered pellets using pressure swing adsorption method,” Saitou et al., Journal of Alloys and Compounds, Vol. 231 (1995), pp. 865-870; and “Separation using encapsulated metal hydride,” Heung, L. K., U.S. Department of Energy Report No. WSRC-RP-00668, published Jun. 1, 2001, the disclosures of each of which is incorporated herein by reference.

In some embodiments, an inert material will be intermixed with the hydrogen fixing material within the purification bed. When used, the inert material should have a size and/or density that will provide good mixing and a uniform distribution amongst the hydrogen fixing material. By providing a more uniform distribution of inert material amongst the hydrogen fixing material, problems that might otherwise be associated with regions containing high concentrations of hydrogen fixing material are avoided. By way of example, where the hydrogen fixing material is a metal hydride-forming material, it is well known that the material expands as hydrogen is absorbed and the metal hydride is formed. By providing a more uniform distribution of inert material amongst the metal hydride-forming material within the bed, metal hydride formation is accompanied by a more asymmetrical or random expansion of the materials, which in turn reduces localized stresses on the vessel that contains the purification bed.

Suitable inert materials will have a melting point at a temperature above the range of temperatures that occurs within the purification bed during operation, and more preferably, above the melting point of the selected hydrogen fixing material. In some embodiments, the inert material selected will also have a high heat capacity so as to function as a heat sink within the purification bed. More specifically, when the hydrogen fixing material is a metal hydride-forming material, a significant amount of heat is generated as hydrogen is absorbed and metal hydride is formed. Additional hydrogen can be fixed from the intermediate reformate by removing at least a portion of this reaction heat. The reaction heat can be removed from the bed by providing heat exchanging means within or around the purification bed, but preferably, heat removal from the hydrogen fixing material is at least in part achieved by using an inert material having a high heat capacity so that the heat is absorbed within the bed itself. Heat absorption by such an inert material effectively stores the heat within the bed for later use during hydrogen desorption.

Suitable non-metallic inert materials can include a wide array of materials including diatomaceous earth, Kieselguhr, lignin, and polymeric materials including open cell foam plastics. When it is desired that the inert materials also function as a heat sink within the purification bed, suitable inert materials include metallic materials having a high heat capacity and good thermal conductivity. Such metallic inert materials can include iron, nickel, copper, steel and aluminum as well as alloys and mixtures of the same. Suitable forms of inert materials can include powders, particulates, agglomerates, foams, foils, pellets, extrudates, and various composite forms wherein the inert is bound to the hydrogen fixing material. Polymeric binders such as block copolymers can be included to bind inert and hydrogen fixing materials into composites. Furthermore, where the inert is a metallic material, the hydrogen fixing material may be sintered with the inert material to form a composite. However, because composites tend to form fines over repeated absorption/desorption cycles, an intimate mixture of particulate inert and hydrogen fixing materials is preferred.

The purification bed preferably comprises a vessel having an inlet, an outlet, and a gas passage extending from the inlet to the outlet. The hydrogen fixing material and any inert materials are preferably disposed within the gas passage. The purification bed vessel is preferably cylindrical or tubular in form so as to provide a flow-through configuration for the passage of the intermediate reformate. Valving or a manifold upstream of the purification bed inlet controls the flow of reformats through the vessel, and indirectly thereby, the partial pressure of hydrogen within the purification bed.

In some embodiments, heat exchanging means can be provided within the purification bed for removing heat from or delivering heat to the hydrogen fixing material. Such heat exchanging means can include heat exchanging means such as those described for use in the reactor vessel, with the exception, that no oxidation reaction should be performed within the purification bed. However, heated oxidation products produced externally to the purification bed vessel can be directed to heat exchanging means incorporated into the purification bed.

An apparatus of the instant invention can further comprise a plurality of purification beds so that as a first purification bed becomes saturated by fixed hydrogen, the intermediate reformate may be diverted to a second purification bed so as to continue hydrogen fixing while fixed hydrogen is released from the first purification bed. In such an embodiment, a manifold disposed downstream of the reforming reactor is used to divert the flow of reformate between the purification beds. Furthermore, where each of the purification beds includes heat exchanging means, it is preferred that the heat exchanging means be operably connected to each other so that heat generated by the fixing of hydrogen in one bed can be recovered and used to desorb hydrogen in a second bed. Where the apparatus comprises a plurality of purification beds, the purification beds can be disposed within a common vessel, or disposed within separate vessels.

In similar fashion, in some embodiments an apparatus of the instant invention can further comprise a plurality of reforming catalyst beds so that as the carbon dioxide fixing material in a first catalyst bed becomes saturated by fixed carbon dioxide, the flow of reactants can be diverted to a second catalyst bed and the production of intermediate reformate continued while fixed carbon dioxide is released from the first catalyst bed. In such an embodiment, a manifold or combination of valves disposed upstream of the reforming reactor is used to divert the flow of reactants between the first and second catalyst beds. Where the apparatus comprises a plurality of reforming catalyst beds, the catalyst beds can be disposed within a common reactor vessel or within separate reactor vessels.

The apparatus of the instant invention can further comprise a hydrogen storage device in fluid communication with the purification bed for storing at least a portion of the hydrogen-rich gas. The hydrogen storage device can be selected from hydrogen storage devices that are known in the art. Preferably, the hydrogen storage device will comprise a storage vessel that is suitable for containing the hydrogen in a desired form, including but not limited to, a high pressure gas, liquefied gas or solid.

By way of example, the hydrogen storage device may comprise a compressor and a high pressure storage vessel operably connected with the compressor for storing a high pressure gas. Another suitable hydrogen storage device can comprise a storage vessel and a hydrogen fixing material disposed within the storage vessel for storing hydrogen at a various temperatures and pressures. Such hydrogen fixing materials can include any material that will reversibly fix hydrogen, including but not limited to, activated carbon, carbon composites, fullerene-based materials, microporous carbon materials, layered carbon nanostructures in the form of nanotubes, nanofibrils, nanoshells and nanofibres, carbon materials having turbostratic microstructures, carbon-metal hybrid materials, metal hydride-forming materials, composites of metal hydride and an interface activation composition comprising one or more platinum group metals, metal hydrides imbedded in polymeric materials, alloys of titanium, vanadium, chromium and manganese, with or without additional elements, magnetic hydrogen-absorbing materials, and nanostructures formed from light elements selected from the second and third rows of the periodic table. In still other embodiments, the hydrogen storage device can comprise a liquefaction unit capable of converting a hydrogen-rich gas to a liquefied gas and a storage vessel operably connected in fluid communication with the liquefaction unit that is suitable for containing the liquefied gas. A more detailed description of a hydrogen storage device suitable for use in the apparatus and methods of the instant invention may be had by reference to U.S. patent application entitled “Method And Apparatus For Providing A Continuous Stream Of Reformate”, by James F. Stevens, filed Apr. 19, 2004 (Attorney Docket No. X-0169), the description of which is incorporated herein by reference. The storage vessel may be portable, modular, skid mounted or fixed in place.

The apparatus of the instant invention can optionally include a controller in communication with the reforming reactor(s), the purification bed(s), and/or other elements of the hydrogen generation apparatus for monitoring the operation of the apparatus. In some embodiments, the controller can provide operational control over the elements of the apparatus such as controlling the cycling of the reforming reactor/catalyst bed(s) between reforming and non-reforming modes and the cycling of the purification bed(s) between hydrogen fixing and desorption, thereby simplifying the operation of the overall apparatus. Suitable controllers can comprise a processor and memory with stored routines such as are well known in the art. An input-output interface can be located proximate or remote from the processor to enable manual input of data and instruction by an operator. In the alternative, suitable controllers can include electronics for monitoring the operations of the reforming reactor/catalyst bed(s), the purification bed(s) and other components of the apparatus. In addition, the hydrogen generation apparatus can include sensor(s) in communication with the controller to provide data concerning reformate and gas compositions, flow rates, as well as temperature and pressure signals at various locations within the apparatus.

Method for Hydrogen Generation

The instant invention also provides a method for generating hydrogen by reacting a hydrocarbon fuel in a catalyst bed comprising a reforming catalyst, carbon dioxide fixing material, and optionally a water gas shift catalyst, to produce a reformate comprising hydrogen and carbon dioxide. At least a portion of the carbon dioxide in the reformate is fixed by the carbon dioxide fixing material to produce fixed carbon dioxide and an intermediate reformate that is rich in hydrogen. Hydrogen is removed from the intermediate reformate by flowing the intermediate reformate through a first purification bed that comprises a hydrogen fixing material to produce fixed hydrogen and a hydrogen-depleted gas that then flows out of the purification bed. Fixed hydrogen is released from the first purification bed to produce hydrogen-rich gas. Descriptions of suitable reactors and vessels, catalyst bed components, purification bed components, and the like, are provided in detail above.

The method includes the step of converting a hydrocarbon fuel within a reforming catalyst bed to an intermediate reformate that comprises hydrogen and low levels of carbon oxides. As used herein, the term “hydrocarbon fuel” includes organic compounds having C—H bonds which are capable of producing hydrogen from a partial oxidation, autothermal and/or a steam reforming reaction. The presence of atoms other than carbon and hydrogen in the molecular structure of the compound is not excluded. Thus, suitable fuels for use in the apparatus and methods of the instant invention can include, but are not limited to, hydrocarbon fuels such as natural gas, methane, ethane, propane, butane, naphtha, gasoline, and diesel fuel, and alcohols such as methanol, ethanol, propanol, and the like. Preferably, the hydrocarbon fuel will be a gas at 30° C. and standard pressure. More preferably, the hydrocarbon fuel will comprise a component selected from the group consisting of methane, ethane, propane, butane, and mixtures of the same. In some embodiments, the hydrocarbon fuel is desulfurized to at least partially remove the sulfur-containing compounds from the fuel so that a desulfurized fuel is directed to the reforming reactor.

A source of water is also operably connected to the reactor vessel. Water can be introduced to the reforming reactor as a liquid or vapor, but is preferably in the form of steam. The ratio of the reforming reactor feeds is determined by the nature of the reaction(s) and the desired operating conditions as they affect both operating temperature and yield. In embodiments where the reforming reaction utilizes a steam reforming catalyst, the steam to carbon ratio is typically in the range between about 8:1 to about 1:1, preferably between about 5:1 to about 1.5:1 and more preferably between about 4:1 to about 2:1. When the catalyst bed is operated in a non-reforming mode, such as when the carbon dioxide fixing material is calcinated to release fixed carbon dioxide, the flow of steam to the bed is reduced and in some embodiments interrupted. In addition, steam temperature can vary depending on its purpose and/or the mode of operation of the reactor. For example, when small volumes of steam are used to purge the reactor prior to and/or following the calcination of the carbon dioxide fixing material, the steam temperature is preferably at a temperature that approximates the selected reforming reaction temperature. In contrast, when larger volumes of steam are used to hydrate the calcinated carbon dioxide fixing material as described herein, the steam will typically comprise a low temperature steam.

When the reforming reaction is a steam reforming reaction, hydrocarbon fuel, steam, or a mixture of hydrocarbon fuel and steam are directed into the reactor vessel at a reforming temperature between about 400° C. and about 800° C., more preferably, between about 450° C. and about 750° C. and still more preferably, between about 500° C. and about 700° C. Where the reforming reaction is an autothermal reforming reaction, air, oxygen, or oxygen enriched air is also directed into the reactor vessel and the reforming temperature is preferably in the range between about 550° C. and about 900° C.

The catalyst bed and/or reactor feeds can be heated to the selected reforming reaction temperature with heat exchanging means and heat generating means such as are described herein. For instance, electrically resistant heating coils can be incorporated within or in close proximity to the catalyst bed. Similarly, coils, fins and other heat exchanging surfaces, as well as heat pipes and other heat transfer devices can be incorporated into the catalyst bed to achieve and maintain a reforming reaction temperature. In still other embodiments, a reforming reaction temperature can be achieved by flowing gas(es) such as heated streams of helium, nitrogen, steam, as well as heated exhaust gases from a fuel cell or the tail gas of a metal hydride storage system through the catalyst bed.

The heating of the catalyst bed for the reforming reaction and/or calcination reaction can be achieved by providing a continuous supply of heat to the bed that is sufficient to achieve and maintain the desired temperature throughout the reaction. In an alternative, the bed may initially be heated to the desired reaction temperature and then discontinued as the reaction proceeds. In such an embodiment, the bed temperature should be monitored and additional heat provided as needed to maintain the desired reaction temperature.

The reforming reaction converts the reactor feeds to fixed carbon dioxide and an intermediate reformate that is rich in hydrogen. When the carbon dioxide fixing material is effectively fixing carbon dioxide, the intermediate reformate exiting the reactor vessel comprises greater than about 90%, preferably greater than about 95%, more preferably greater than about 96%, and still more preferably greater than about 97% hydrogen by volume. Further, where the hydrocarbon fuel comprises natural gas, the intermediate reformate comprises less than about 1% methane and less than about 1% combined of carbon monoxide and carbon dioxide. More specifically, the concentration of carbon monoxide in the intermediate reformate is less than about 50 ppm, preferably less than about 25 ppm, more preferably less than about 10 ppm, and still more preferably less than about 5 ppm. Conventional fuel processors and reforming reactors typically produce reformate having significantly higher levels of carbon oxides that tend to blanket and otherwise interfere with hydrogen fixing materials such as are used in the purification beds of the instant invention.

In some embodiments, one or more components of the intermediate reformate can be monitored so as to detect a change in reformate composition that would indicate at least partial saturation of the carbon dioxide fixing material. When fixed carbon dioxide is to be released from the carbon dioxide fixing material, the flow of hydrocarbon fuel and steam is reduced so as to interrupt the reforming reaction. In an some embodiments, the reactor vessel is purged with a small volume of high temperature steam prior to calcinating the carbon dioxide fixing material. Between about 1 and about 5 reactor volumes of steam should be used for purposes of purging the reactor. Although referred to as “high temperature”, the temperature of this purge steam should be at least about the selected reforming reaction temperature.

During the reforming reaction, the carbon dioxide fixing material fixes carbon dioxide. Where the carbon dioxide fixing material is calcium oxide, the fixed carbon dioxide is in the form of calcium carbonate. As used herein, the term “calcine” and its derivatives are intended to refer to those reactions or processes wherein a carbon dioxide fixing material is heated to a temperature at which fixed carbon dioxide is released due to thermal decomposition, phase transition or some other physical or chemical mechanism. As such, a temperature at which fixed carbon dioxide is released is referred herein to as a “calcination temperature”. In a preferred embodiment, the calcination temperature for the carbon dioxide fixing material will be above the selected reforming reaction temperature. More specifically, the calcination temperature of the fixing material will be above about 550° C., preferably above about 650° C., and more preferably above about 750° C. Although not to be construed as limiting of suitable carbon dioxide fixing materials, a preferred calcination reaction has the equation:
CaCO₃→CO₂+CaO (calcination) (V).

The temperature of the catalyst bed can be raised to a calcination temperature using the heat generating and heat exchanging means described herein. In some embodiments, the carbon dioxide fixing material can be heated to a calcination temperature with heat generated by an oxidation reaction conducted within the reactor vessel. In such an embodiment, an oxidant is directed into the reactor in such a manner that the oxidant mixes and reacts with hydrocarbon fuel. The temperature of the oxidation reaction and the heated oxidation products can be adjusted by adjusting the fuel and oxidant feed streams and/or by directing a temperature moderator into the reactor. Suitable temperature moderators can include a fluid material selected from the group consisting of steam, water, air, oxygen-depleted air, carbon dioxide, nitrogen and mixtures of the same. A more detailed description of methods that utilize heated oxidation products in the calcination of carbon dioxide fixing material may be found in U.S. patent application “Reactor and Apparatus for Hydrogen Generation”, Stevens et al, filed Apr. 19, 2004 (Attorney Docket No. X-0186), the contents of which are incorporated by herein reference.

As the temperature of the carbon dioxide fixing material reaches a calcination temperature, fixed carbon dioxide is liberated from the fixing material and is directed out of the catalyst bed as a carbon dioxide-laden gas. The composition of the carbon dioxide-laden gas can be monitored to determine when a desired level of carbon dioxide has been liberated from the catalyst bed. When such a level is detected, the calcination reaction is interrupted and the catalyst bed is allowed to cool to a reforming temperature before resuming the reforming reaction. The cooling of the catalyst bed can occur through radiation cooling or by incorporating a heat transfer device within the catalyst bed. In an optional but highly preferred embodiment, the reactor vessel can be purged with a small volume of high temperature steam before resuming the reforming reaction. The volume of steam used to purge the bed should be between about 1 and about 5 reactor volumes. The temperature of this purge steam should be at least about the reforming reaction temperature. When the reactor vessel is purged following calcination, the catalyst bed can be rapidly cooled to a reforming temperature without the use of heat transfer devices.

Repeated reforming/calcination cycles tend to decrease the fixing capacity of the carbon dioxide fixing materials resulting in a reduction of the hydrocarbon to hydrogen conversion rates. In an effort to minimize losses in carbon dioxide fixing capacity, it has been found that hydration of the carbon dioxide fixing material between one or more cycles can to an extent restore and sustain the fixing capacity of such materials at acceptable levels. In addition, it has been found that such hydration improves the reaction efficiencies for both the conversion rate of hydrocarbon fuel to hydrogen and the shift conversion of carbon monoxide to hydrogen and carbon dioxide.

Hydration of the calcinated carbon dioxide fixing material can occur at virtually any time, including but not limited to, after each calcination step, during reactor start-up and/or shut-down procedures, after the performance of a number of reforming/calcination cycles or can be triggered by detecting an undesirable change in reformate composition. By way of example, hydration can be triggered when the level of a monitored reformate component exceeds or falls below a predetermined level that is indicative of when the fixing capacity of the carbon dioxide fixing material has been impaired. Reformate components that can be monitored for this purpose include, but are not limited to, hydrogen, carbon monoxide, carbon dioxide, and unreacted hydrocarbon fuel.

Hydration can be achieved by contacting calcinated carbon dioxide fixing material with water, preferably in the form of steam. After calcination, the catalyst bed is at an elevated temperature relative to the reforming temperature. Hydration is preferably conducted at a hydration temperature that is below the calcination temperature, and more preferably, below the reforming temperature. Specifically, the hydration temperature should be less than 600° C., preferably below about 500° C., more preferably below about 400° C. and even more preferably below about 300° C. For instance, sufficient hydration can be achieved by passing steam at 200° C. through the catalyst bed.

Not to be bound by theory, but in embodiments where the carbon dioxide fixing material is calcium oxide, repeated cycles of reforming/calcinating carbon dioxide tends to compact the calcium oxide and form crystalline-like structures. Through hydration, at least a portion of the calcinated calcium oxide is converted with steam to calcium hydroxide. The formation of calcium hydroxide within the catalyst bed tends to break up and disrupt the compacted and crystalline-like structures and thereby increase the surface area of calcium oxide available for carbon dioxide fixing in subsequent cycles.

The amount of steam that is needed to achieve sufficient hydration will vary depending on the volume of the catalyst bed, the surface area of the carbon dioxide fixing materials within the bed, the type of fixing material used, the structure of catalyst(s) and fixing materials within the bed and the flow rate of steam through the bed. Where the fixing material comprises calcium oxide, sufficient steam should be passed through the catalyst bed to convert at least about 10% of the calcium oxide to calcium hydroxide to achieve the desired effect. More specifically, at least about 0.03 kg of steam per kilogram of calcium oxide is needed to achieve sufficient hydration. Greater quantities of steam may be needed where stream flow rates are high. A more detailed description of the hydration of carbon dioxide fixing materials may be found in U.S. patent application entitled “Reforming With Hydration Of Carbon Dioxide Fixing Material”, by Stevens et al., filed on Apr. 19, 2004 (Attorney Docket No. X-0137), the description of which is incorporated herein by reference.

The intermediate reformate is continuously removed from the reactor as it is produced and can optionally be directed to a polishing unit downstream of the reactor to remove one or more impurities from the reformate. When used, the components of the polishing unit will depend in part on the composition of the intermediate reformate and the nature and composition of the hydrogen fixing material in the purification bed. For instance, where the hydrogen fixing material comprises a metal hydride-forming material, the polishing unit preferably comprises a drying unit suitable for removing water from the intermediate reformate prior to flowing the intermediate reformate through the purification bed. Where the level of carbon monoxide in the intermediate reformate is considered to be excessive, a preferred polishing unit can comprise a methanation reactor. Because the level of carbon oxides in the intermediate reformate is particularly low, the amount of hydrogen that is required to convert the carbon oxides to methane is not considered to be significant. Further, methane can remain in the hydrogen-rich reformate stream without creating a deleterious effect on catalyst systems downstream. It should also be noted that one or more polishing units can be used to condition the intermediate reformate and that such units can be the same or different. For instance in a preferred embodiment, the apparatus comprises a methanation reactor with a drying unit disposed downstream of the methanation reactor.

Hydrogen can be removed from the intermediate reformate by flowing the reformate through a first purification bed comprising a hydrogen fixing material to produce a hydrogen-depleted gas and fixed hydrogen. As the intermediate reformate flows through the purification bed, hydrogen is selectively absorbed, adsorbed, reacted or otherwise removed from the reformate gas stream by the hydrogen fixing material that is disposed within the bed. The resulting hydrogen-depleted gas passes through and out of the purification bed. It has been found that the continuous flow of intermediate reformate and hydrogen-depleted gas through the hydrogen fixing material tends to prevent the blanketing effect that inert gases and impurities such as carbon oxides can have on hydrogen fixing materials in closed-end hydrogen storage vessels. As a result, the efficiency of the hydrogen fixing reaction is improved.

Where the hydrogen fixing material is a metal hydride-forming material, a significant amount of heat is generated as the hydrogen and metal hydride-forming material react to form metal hydride. In order to promote this reaction and the fixing of hydrogen, heat is optionally but preferably removed from the hydrogen fixing material during the reaction. Heat can be removed from the hydrogen fixing material by providing heat exchanging means within the purification bed. In some embodiments, an inert particulate material having a high heat capacity, which has been intermixed with the hydrogen fixing material, absorbs the heat as it is generated and thereby stores the heat within the purification bed. Furthermore, unlike closed-end hydrogen storage vessels, the continuous flow of intermediate reformate and hydrogen-depleted gas through the hydrogen fixing material removes a portion of the reaction heat and reduces the heat transfer requirements during hydrogen fixing.

As hydrogen is removed from the intermediate reformate, the balance of the intermediate reformate components pass through and out of the purification bed in the form of a hydrogen-depleted reformate or gas. In some embodiments, the composition of the hydrogen-depleted gas is monitored in order to determine when the hydrogen fixing material within the purification bed becomes at least partially saturated with fixed hydrogen. A compositional change that is indicative of such saturation is when the level of hydrogen in the hydrogen-depleted reformate begins to rise sharply from either a flat or declining value, a point which is sometimes referred to as “hydrogen breakthrough”.

Fixed hydrogen can be released from the purification bed by imposing a change in temperature, pressure, or a combination of changes in temperature and pressure on the hydrogen fixing material. Preferably, fixed hydrogen is released by providing heat to the hydrogen fixing material and/or decreasing the partial pressure of hydrogen on the hydrogen fixing material. For instance, when hydrogen breakthrough occurs, the flow of intermediate reformate to the purification bed is discontinued or interrupted and the bed is optionally purged to remove any residual hydrogen-depleted gas remaining within the purification bed. The interruption of the flow of intermediate reformate to the purification bed causes a drop in the partial pressure of hydrogen within the bed. Under such conditions, the fixed hydrogen begins to revert to hydrogen and hydrogen fixing material. Where the fixed hydrogen is in the form of a metal hydride, the metal hydride reverts to back hydrogen and a metal hydride-forming material in a “desorption” reaction that consumes heat. Therefore, the purification bed can optionally be heated in order to promote hydrogen desorption from the metal hydride. Where the purification bed further comprises an inert material having a high heat capacity that has been mixed with the hydrogen fixing material, the inert material functions as a heat sink and stores at least a portion of the heat that is generated as hydrogen is initially fixed by the metal hydride-forming material. This heat is available within the purification bed and is absorbed by the metal hydride during hydrogen desorption. Depending on the heat capacity of such an inert material, additional heating of the metal hydride may be required to fully desorb fixed hydrogen. In addition or in the alternative, heat can be provided to the metal hydride bed by conventional heat generating or heat exchanging means as described herein.

To provide for the continuous purification of intermediate reformate, a method of the instant invention can further include the steps of diverting the intermediate reformate from a first purification bed and flowing the intermediate reformate through a second purification bed comprising a hydrogen fixing material to produce a hydrogen-depleted gas and fixed hydrogen. Specifically, such a method enables fixed hydrogen to be released from the first purification bed while the intermediate reformate continues to flow through and fix hydrogen within a second purification bed. In such an embodiment, hydrogen can be released from the first purification bed by heating the hydrogen fixing material within the first purification bed at least in part with heat derived from the second purification bed. More specifically, heat exchanging devices disposed within each of the purification beds that are integrated enable heat to be transferred between two or more purification beds. Further, in such an embodiment, fixed hydrogen is released from the second purification bed by imposing a change in temperature, pressure, or a combination of changes in temperature and pressure on the hydrogen fixing material.

### DETAILED DESCRIPTION OF THE FIGURES

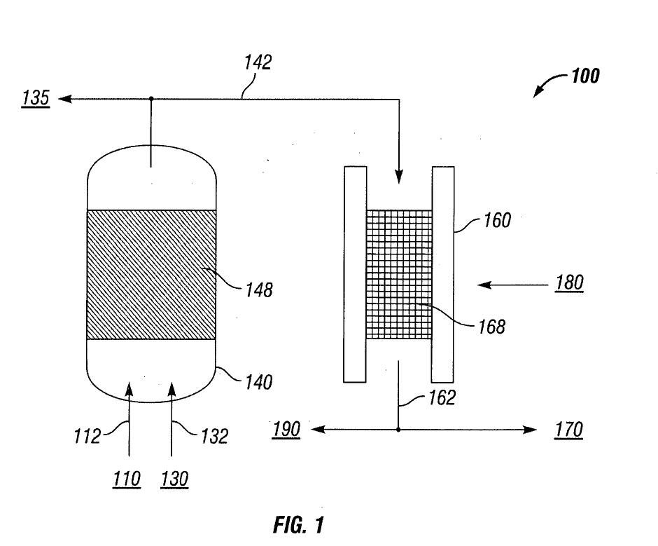

FIG. 1 shows apparatus 100 for generating hydrogen that has reforming reactor 140 and purification bed 160. Hydrocarbon fuel 112 is directed from a source 110 into the reactor along with steam 132 derived from source 130. The hydrocarbon fuel and steam are combined and directed through the catalyst bed 148 that comprises reforming catalyst, carbon dioxide fixing materials, and a water gas shift catalyst. The hydrocarbon and steam are reacted in the catalyst bed to produce a reformate comprising hydrogen and carbon dioxide. At least a portion of the carbon dioxide is fixed by the carbon dioxide fixing material in the catalyst bed to give an intermediate reformate that is rich in hydrogen and fixed carbon dioxide.

The carbon dioxide fixing material within catalyst bed 148 is heated to a calcination temperature to release fixed carbon dioxide from the catalyst bed. Catalyst bed 148 is heated to a calcination temperature through the use of heat exchanging means (not shown) or by heated oxidation products generated either within or external to reactor 140. During the calcination of the carbon dioxide fixing material, the reforming reaction is interrupted and the carbon dioxide-laden gases released from catalyst bed 148 are diverted to a vent or sequestration unit 135.

During the reforming reaction, the hydrogen-rich reformate 142 is directed to purification bed 160, which comprises a hydrogen fixing material 168. Reformate 142 is flowed through purification bed 160 where the hydrogen is absorbed by hydrogen fixing material 168 to produce fixed hydrogen and hydrogen-depleted reformate 162. The hydrogen-depleted reformate flows out of the purification bed and is directed downstream to vent or processing unit 170, while fixed hydrogen is retained within the bed by hydrogen fixing material 168. Fixed hydrogen is released by interrupting the flow of reformate 142 to the purification bed, purging the bed of any residual hydrogen-depleted reformate, and providing heat 180 to the bed. Heat 180 is provided by heat exchanging means embedded with the hydrogen fixing material (not shown) and/or by mixing inert materials having a high heat capacity with the hydrogen fixing material. In the latter embodiment, the inert material functions as a heat sink retaining heat that is generated when hydrogen is initially fixed by the hydrogen fixing material and storing that heat for use when hydrogen is to be desorbed. The fixed hydrogen released from the purification bed is the form of a hydrogen-rich gas that is directed to downstream hydrogen storage/user 190.

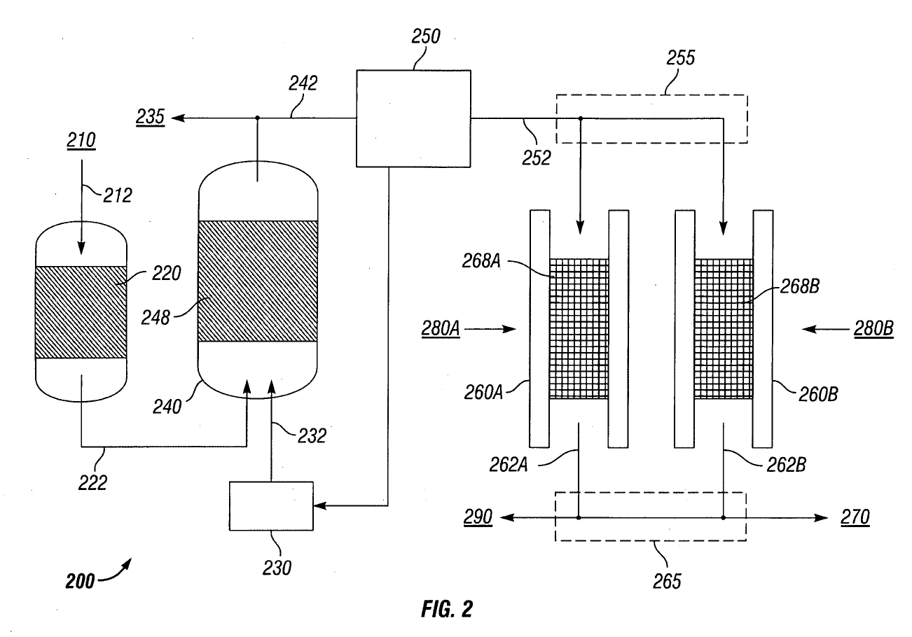

FIG. 2 illustrates apparatus 200 for generating hydrogen. Apparatus 200 comprises a source of hydrocarbon fuel 210, a desulfurization unit 220 that receives hydrocarbon fuel 212 and removes sulfur-containing compounds from the fuel to provide desulfurized fuel 222 to reforming reactor 240. Steam 232, derived from steam source 230, is combined with the desulfurized fuel 222 and directed into catalyst bed 248. The desulfurized fuel and steam react in the catalyst bed to produce a reformate comprising hydrogen and carbon dioxide. The carbon dioxide is fixed by the carbon dioxide fixing material in the catalyst bed to give an intermediate reformate 242 rich in hydrogen and fixed carbon dioxide. When the carbon dioxide fixing material becomes at least partially saturated with fixed carbon dioxide, the reforming reaction is interrupted and the fixed carbon dioxide is heated to a calcination temperature in order to release fixed carbon dioxide. The heating of the catalyst bed to a calcination temperature can be achieved through the use of heat exchanging means (not shown) and/or through the use of heated oxidation products generated either within or external to reactor 240. The carbon dioxide-laden gases released from catalyst bed 248 are diverted to vent or sequestration unit 235.

Disposed intermediate of reactor 240 and purification beds 260A and 260B is polishing unit 250. As illustrated in FIG. 2, polishing unit 250 is a drying unit for removing water from intermediate reformate 242. Water 231 recovered from the intermediate reformate can be recycled and converted to steam for use in the reforming reaction in reactor 240.

During the reforming reaction, intermediate reformate 242 is dried in drying unit 250 and directed purification beds 260A and 260B, each of which comprises hydrogen fixing material 268A and 268B, respectively. Broken lines 255 represent a manifold for controlling and diverting the flow of reformate 252 between purification beds 260A and 260B. Initially, water-depleted reformate 252 is flowed through purification bed 260A where the hydrogen is absorbed by hydrogen fixing material 268A to produce fixed hydrogen and a hydrogen-depleted reformate. When hydrogen fixing material 268A becomes at least partially saturated with fixed hydrogen, the flow of reformate 252 is diverted to purification bed 260B where hydrogen is fixed by hydrogen fixing material 268B. Broken lines 265 represent a manifold or a combination of valves downstream of the purification beds where exit lines from the purification bed are combined to control the flow of hydrogen-depleted reformate, and separately therefrom, the flow of hydrogen-rich reformate. Hydrogen-depleted reformate is directed downstream to vent/processing unit 270.

Fixed hydrogen is retained within the beds by hydrogen fixing materials 268A and 268B, respectively. Fixed hydrogen is released from a purification bed by interrupting the flow of reformate 252 to the bed, purging the bed of any residual hydrogen-depleted reformate, and providing heat 280A or 280B to the bed. The heat for releasing fixed hydrogen is transferred to the purification beds by heat exchanging means embedded in the hydrogen fixing material (not shown) and/or by inert materials having a high heat capacity that have been intermixed with the hydrogen fixing material. The fixed hydrogen released from the purification bed is in the form of a hydrogen-rich gas that is directed to downstream hydrogen storage/user 290.

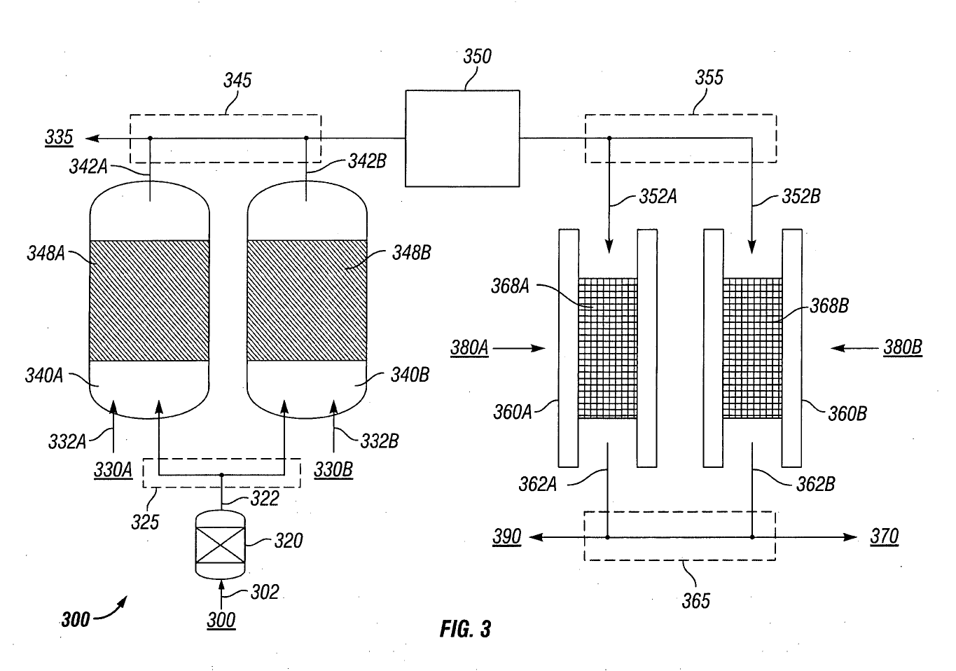

FIG. 3 illustrates hydrogen generating apparatus 300 that is similar to the apparatus shown in FIG. 2 in that apparatus 300 has a desulfurization unit upstream from the reforming reactor to remove sulfur-containing compounds from the hydrocarbon fuel 302, a pair of purification beds, and a drying unit 350 located between the reforming reactor and the purification beds for removing water from the reformate.

Apparatus 300 further comprises a pair of reforming reactors and associated catalyst beds 348A and 348B so that the reforming reaction can be maintained even while the carbon dioxide fixing material within one of the catalyst beds is being calcinated to release fixed carbon dioxide. More specifically, broken lines 325 represent a manifold or combination of valves for controlling the flow of desulfurized fuel 322 to reactors 340A and 340B. Initially, the desulfurized fuel and steam are directed to reactor 340A where the reforming reaction in the catalyst bed produces a reformate that comprises hydrogen and carbon dioxide.

Carbon dioxide is at least partially fixed within catalyst bed 348A by the carbon dioxide fixing material therein. When this carbon dioxide fixing material becomes at least partially saturated with carbon dioxide, the flow of hydrocarbon fuel and steam is diverted to reactor 340B in order to continue the production of intermediate reformate in reactor 340B. The carbon dioxide fixing material within catalyst bed 348A is heated to a calcination temperature to release the fixed carbon dioxide. Carbon dioxide-laden gases are directed out of catalyst bed 348A and reactor 340A. Broken lines 345 represent a manifold or a combination of valves downstream of the reforming reactors where exit lines from the reactors are combined to control the flow of intermediate reformate, and separately therefrom, the flow of carbon dioxide-laden gases from the reactors. Carbon dioxide-laden gases are directed downstream to a vent or sequestration unit 335.

The intermediate reformate is directed downstream to drier 350 where water is removed before reformate 352 is directed to the purification beds 360A and 360B. As illustrated in FIG. 2, the use of a pair of purification beds enables the continuous purification of reformate from upstream reactors even while fixed hydrogen is being released from one of the purification beds.

### EXAMPLES

A purification bed was set up as shown in FIG. 1 where the gas mixture enters the bed from the top and exits from the bottom. Slip-streams were installed for both the inlet gas and the outflow gas to an online mass spectrometer to measure the concentration of various components.

Two different gas compositions were tested, namely, a first mixture of 75% H₂—25% N₂ and a second mixture of 97% H₂—3% CH₄. Both gas mixtures were blended out of stocks of industrial grade pure components. The latter mixture was intended to represent the typical product stream from an absorption enhanced reforming reactor. This mixture was tested for CO concentration and measured to have approximately 10 ppm CO. The actual CO concentration of a reformate stream from an absorption enhanced reforming reactor is anticipated to be much lower, particularly where the catalyst bed comprises a water gas shift catalyst.

The experiments were conducted on the purification bed in a flow-through condition such that the reformate stream enters the purification bed, hydrogen is absorbed and a hydrogen-depleted reformate passes through and out of the purification bed in a one continuous step or operation. The continuous flow of reformate gases through the purification bed reduces the physical blanketing effect of gas impurities on the metal hydride forming material and provides additional cooling by removing a portion of the heat generated by the metal hydride-forming material as hydrogen is absorbed. The absorption cycle was complete as hydrogen breakthrough was observed by the mass spectrometer. Upon reaching hydrogen breakthrough, the reformate gas in-flow and out-flow valves were shut off. The purification bed was then purged to remove any residual reformate gases inside the vessel ensuring that the desorbed gas was a pure hydrogen stream.

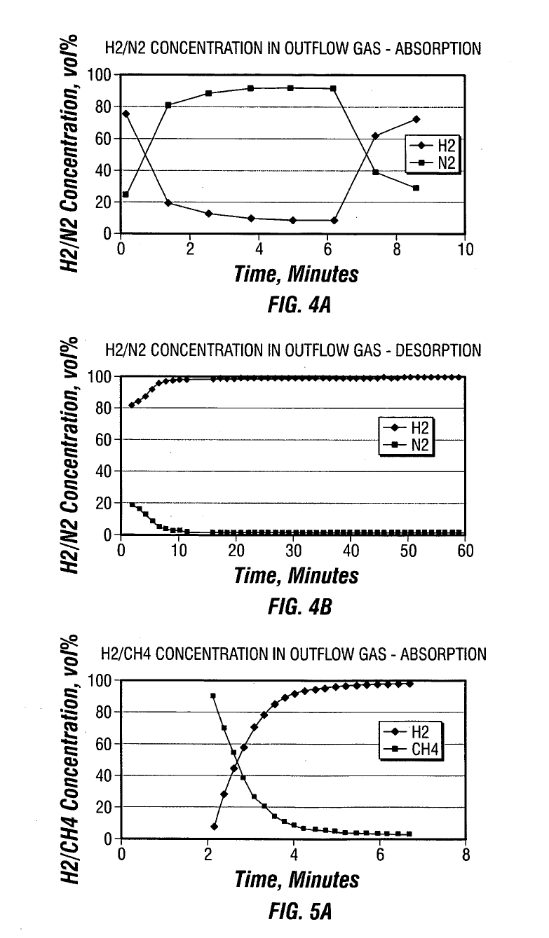

FIGS. 4A and 4B show an absorption/desorption cycle with the 75% H₂—25% N₂ gas mixture. As shown by the data, within the first minutes of the absorption cycle, the nitrogen concentration in the outflow gas increased to over 95% with only a 5% loss of hydrogen. Because of the size and capacity of the device, hydrogen breakthrough occurred after about 6 minutes of absorption. Conversely, the desorption cycle shown in FIG. 4B indicates that a highly pure stream of hydrogen was obtained once the system was purged of residual nitrogen.

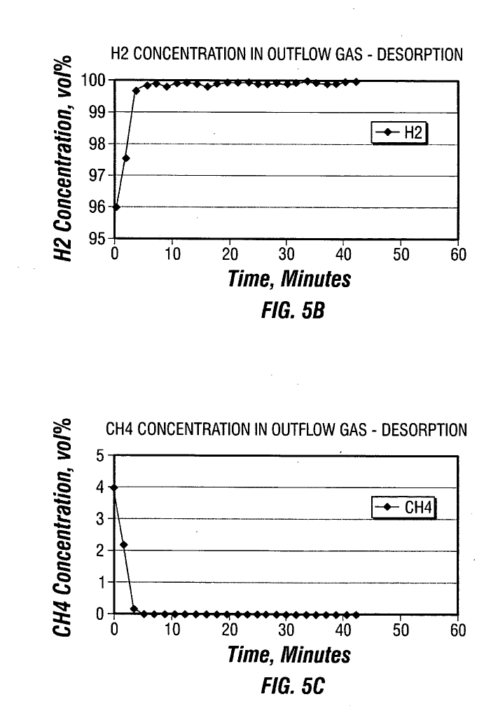

FIG. 5A shows the absorption cycle of the 97% H₂—3% N₂ gas mixture. Hydrogen breakthrough occurred after less than about three minutes of absorption. In practice, the absorption cycle would have been ended once the break-through is reached, however, for experimental purposes, the test continued until the outflow gas composition was the same as the inflow gas composition. Results of the desorption cycle are shown in FIGS. 5B and 5C for hydrogen and methane, respectively. Since the concentration scales for methane and hydrogen are vastly different, they are shown in separate figures. After purging the purification bed, at least a 99.9% hydrogen stream was obtained. While this measurement of the desorbed hydrogen stream was within the accuracy of the mass spectrometer, it is expected that the actual hydrogen concentration may be higher.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

1. An apparatus for generating a hydrogen-rich reformate, the apparatus comprising:
a reactor comprising a catalyst bed, the catalyst bed comprising a reforming catalyst suitable for converting a hydrocarbon fuel to a reformate comprising hydrogen and carbon dioxide, and a carbon dioxide fixing material suitable for fixing within the catalyst bed at least a portion of the carbon dioxide in the reformate to provide an intermediate reformate; and
a first purification bed in fluid communication with the reactor for receiving the intermediate reformate, the first purification bed comprising a hydrogen fixing material suitable for fixing at least a portion of the hydrogen in the reformate to provide a hydrogen-depleted gas and fixed hydrogen.

2. The apparatus of claim 1, further comprising a desulfurization unit disposed upstream of the reactor for removing sulfur-containing compounds from the hydrocarbon fuel.

3. The apparatus of claim 1, wherein the catalyst bed further comprises a water gas shift catalyst.

4. The apparatus of claim 1, wherein the reforming catalyst and carbon dioxide fixing material have a non-uniform distribution within the catalyst bed.

5. The apparatus of claim 1, wherein the reactor further comprises heat exchanging means for delivering heat to and/or removing heat from the carbon dioxide fixing material.

6. The apparatus of claim 1, wherein the first purification bed further comprises a first heat exchanging means for delivering heat to and/or removing heat from the hydrogen fixing material.

7. The apparatus of claim 1, wherein the first purification bed further comprises a vessel having an inlet, an outlet and a gas passage extending from the inlet to the outlet, the hydrogen fixing material disposed within the gas passage.

8. The apparatus of claim 1, wherein the hydrogen fixing material comprises a metal hydride-forming material.

9. The apparatus of claim 1, wherein the first purification bed further comprises an inert material having a high heat capacity.

10. The apparatus of claim 1, further comprising a polishing unit disposed upstream from the first purification bed for removing one or more impurities from the intermediate reformate.

11. The apparatus of claim 10, wherein the polishing unit is a drying unit for removing water from the intermediate reformate.

12. The apparatus of claim 10, wherein the polishing unit is a methanation reactor.

13. The apparatus of claim 1, further comprising a hydrogen storage device disposed downstream in fluid communication with the first purification bed.

14. The apparatus of claim 1, further comprising a controller for controlling the operation of the reactor and/or the first purification bed.

15. The apparatus of claim 1, further comprising a second purification bed and a manifold disposed downstream of the reactor for diverting reformate between the first purification bed and the second purification bed.

16. The apparatus of claim 6, further comprising a second purification bed and a second heat exchanging means disposed within the second purification bed, the first and second heat exchanging means operably connected with each other so as to provide heat transfer between the first and second purification beds.

17. A method for generating a hydrogen-rich reformate, the method comprising the steps of:
reacting a hydrocarbon fuel in a catalyst bed comprising a reforming catalyst and carbon dioxide fixing material to produce a reformate comprising hydrogen and carbon dioxide, the carbon dioxide fixing material fixing at least a portion of the carbon dioxide in the reformate to produce an intermediate reformate;
removing hydrogen from the intermediate reformate by flowing the intermediate reformate through a first purification bed comprising a hydrogen fixing material to produce a hydrogen-depleted gas and fixed hydrogen; and
releasing the fixed hydrogen from the first purification bed to produce a hydrogen-rich gas.

18. The method of claim 17, further comprising removing water from the intermediate reformate prior to flowing the intermediate reformate through the first purification bed.

19. The method of claim 17, further comprising methanating the intermediate reformate prior to flowing the intermediate reformate through the first purification bed.

20. The method of claim 17, wherein the catalyst bed further comprises a water gas shift catalyst.

21. The method of claim 17, wherein removing hydrogen from the intermediate reformate further comprises removing heat from the first purification bed.

22. The method of claim 17, further comprising the step of monitoring the composition of the hydrogen-depleted gas.

23. The method of claim 17, further comprising the step of interrupting the flow of intermediate reformate through the first purification bed.

24. The method of claim 17, further comprising the step of purging the first purification bed to remove hydrogen-depleted gas prior to releasing the fixed hydrogen.

25. The method of claim 17, wherein the hydrogen fixing material comprises a metal hydride-forming material.

26. The method of claim 17, wherein fixed hydrogen is released from the first purification bed by imposing a change in temperature, pressure or a combination of changes in temperature and pressure on the hydrogen fixing material.

27. The method of claim 17, further comprising the steps of diverting the intermediate reformate from the first purification bed and flowing the intermediate reformate through a second purification bed comprising a hydrogen fixing material to produce a hydrogen-depleted gas and fixed hydrogen.

28. The method of claim 27, wherein fixed hydrogen is released from the first purification bed while the intermediate reformate flows through the second purification bed.

29. The method of claim 27, wherein fixed hydrogen is released from the first purification bed by heating the hydrogen fixing material within the first purification bed with heat derived at least in part from the second purification bed.

30. The method of claim 27, further comprising the step of releasing fixed hydrogen from the second purification bed by imposing a change in temperature, pressure or a combination of changes in temperature and pressure on the hydrogen fixing material in the second purification bed.
